(19) United States
(12) Patent Application Publication
(10) Pub. No.: US 2015/0145360 A1
(43) Pub. Date: May 28, 2015

(54) Stator Frame For Motor

(71) Applicant: TYCO ELECTRONICS JAPAN G.K., Kanagawa (JP)

(72) Inventors: Yuya Okada, Kanagaw (JP); Shinji Yamada, Kanagawa (JP)

(73) Assignee: TYCO ELECTRONICS JAPAN G.K., Kanagawa (JP)

(21) Appl. No.: 14/554,538

(22) Filed: Nov. 26, 2014

(30) Foreign Application Priority Data
Nov. 27, 2013 (JP) 2013-245318

(51) Int. Cl. H02K 11/00

(52) U.S. Cl. CPC H02K 11/0094
USPC 310/71

(57) ABSTRACT

A stator frame is disclosed having a substantially annular conductor plate, a connector receiving member, a plurality of wire connecting members, and a substantially annular insulating stator frame housing. The conductor plate has an inner peripheral edge defining an O-shaped opening. The connector receiving member is positioned on an outer peripheral side of the stator frame. The wire connecting members are positioned on a conductor plate surface of the conductor plate along the inner peripheral edge, each wire connecting member being connected to first or second end portions of stator windings, and having an electrical connection with the connector receiving member. The stator frame housing is mounted to a stator, and covers the conductor plate except for the conductor plate surface the wire connecting members are positioned thereon.

### CROSS-REFERENCE TO RELATED APPLICATION

This application claims priority under U.S.C. §119(a)-(d) to Japanese Patent Application No. 2013-245318, dated Nov. 27, 2013.

### FIELD OF THE INVENTION

The present invention generally relates to a stator frame for electric motor, and more specifically, a stator from used for a three-phase electric motor.

### BACKGROUND

Japanese Patent No. 2001-145325 discloses a conventional multi-position, motor-mounted electrical connector positioned on a stator frame. The stator frame is integrated on the motor and positioned to mate with a complementary mating connector to form an external connection. The electrical connector includes a conductor portion having wire connecting members connected to end portions of respective stator excitation windings within the motor, and a plurality of contacts. While an electrical connection of the respective end portions of the stator windings with cables from an external power supply can be performed without using additional relay parts, the conventional electrical connector and stator frame have the disadvantage of preventing a fully automatic manufacturing process from being implemented to assemble the motor.

For example, the wires used to form the stator winding have an insulating external sheath, a portion of which must be removed prior to the stator windings being connected to the conductor portion. Such removal is not conducive to automation, because the stator windings are only connected to the conductor portion after the motor has been partially assembled. Therefore, automation of connection of the excitation wirings to the conductor portion is difficult.

Accordingly, there is a need for a stator frame which allows for the automation of the assembly step whereby the wire connecting members are connected to the end portions of stator windings.

### SUMMARY

A stator frame is disclosed having a substantially annular conductor plate, a connector receiving member, a plurality of wire connecting members, and a substantially annular insulating stator frame housing. The conductor plate has an inner peripheral edge defining an O-shaped opening. The connector receiving member is positioned on an outer peripheral side of the stator frame. The wire connecting members are positioned on a conductor plate surface of the conductor plate along the inner peripheral edge, each wire connecting member being connected to first or second end portions of stator windings, and having an electrical connection with the connector receiving member. The stator frame housing is mounted to a stator, and covers the conductor plate except for the conductor plate surface the wire connecting members are positioned thereon.

### BRIEF DESCRIPTION OF DRAWINGS

The invention will now be described by way of example, with reference to the accompanying Figures, of which:

FIG. 1 is a perspective view of a motor having a stator frame;

FIG. 2 is a perspective view of a motor-mounted electrical connector mated with a connector receiving member of the stator frame;

FIG. 3 is a perspective view of the connector receiving member and the electrical connector separated;

FIG. 4 is a perspective view of the electrical connector mated with the connector receiving member, each having a locking mechanism;

FIG. 5 is an enlarged view of the locking mechanism;

FIG. 6 is a partial sectional view of the electrical connector mated to the connector receiving member;

FIG. 7 is a front perspective view of the stator frame;

FIG. 8 is a side view of the stator frame.

FIG. 9 is a sectional view of the stator frame, taken along line 9-9 in FIG. 8.

FIG. 10 is a perspective view the stator frame connected to a stator, and a wire crimper prior to the wire connecting members being connected to end portions of the stator windings;

FIG. 11 is a perspective view of the stator frame connected to the stator, where the wire crimper is at the beginning of an operation to crimp the wire connecting members to end portions of stator windings;

FIG. 12 is an enlarged view of a wire connecting member;

FIG. 13 is a perspective view of the wire connecting members connected to the end portions of the stator windings;

FIG. 14 is a perspective view the electrical connector prior to connecting with the connector receiving member;

FIG. 15 is a perspective view of the electrical connector being connected to a complementary mating connector.

### DETAILED DESCRIPTION OF THE EMBODIMENT(S)

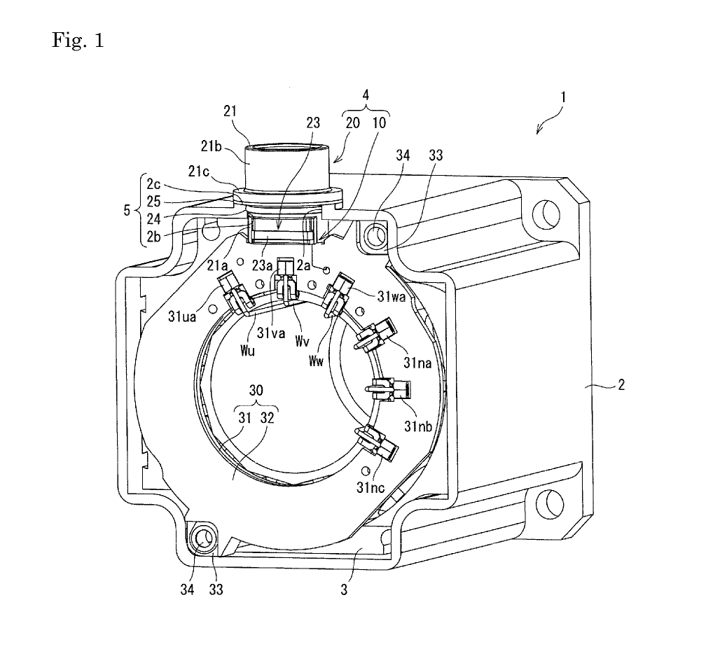

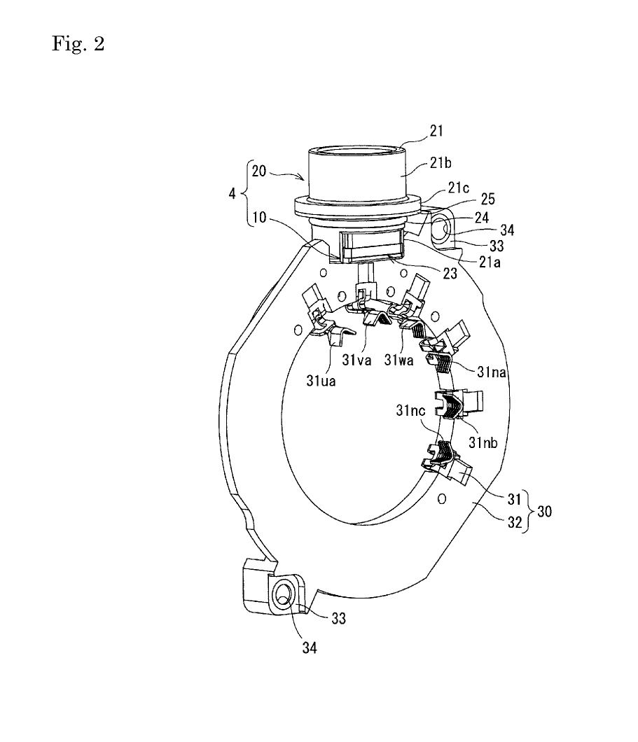

An embodiment of the present invention will now be described with reference to FIGS. 1-15.

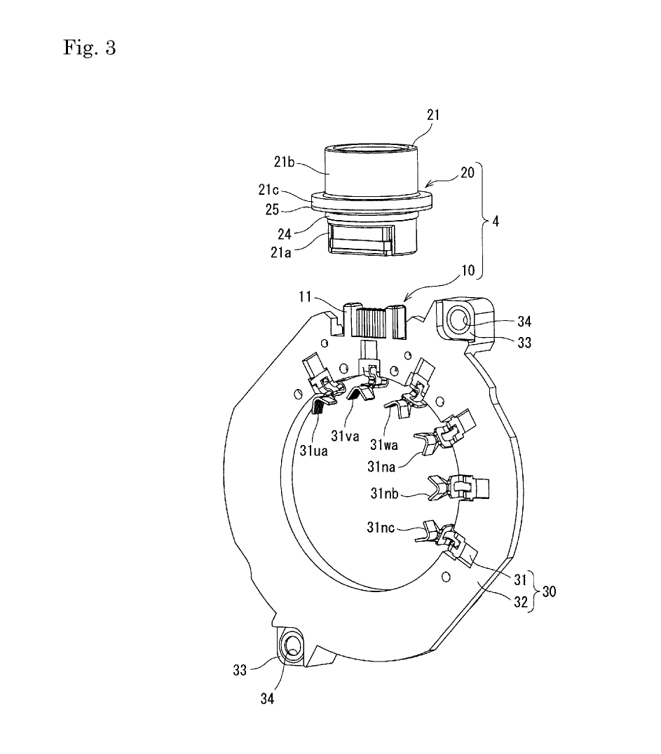

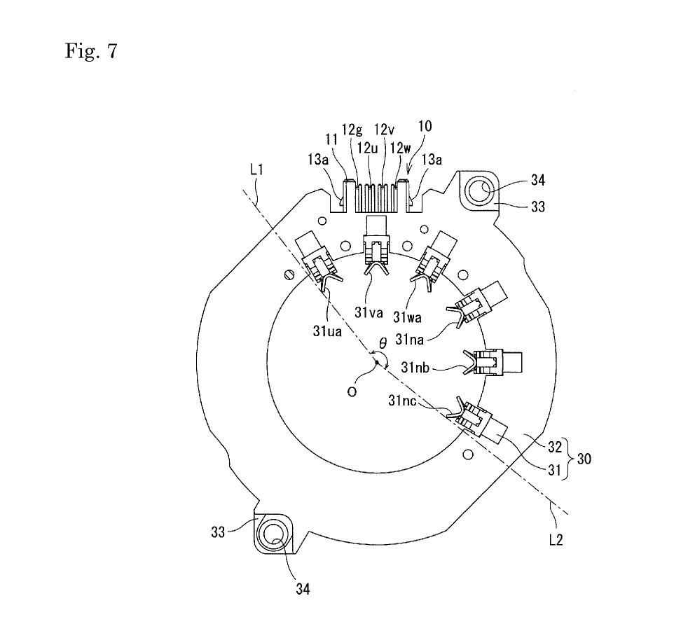

In an embodiment of FIG. 1, a motor 1 has a motor-mounted electrical connector 4. The motor 1 is a three-phase motor and comprises a stator 3, a rotor (not shown), and stator windings (not shown). The stator windings include a U-phase winding Wu, a V-phase winding Wv and a W-phase winding Ww. The stator 3, the rotor and the stator windings Wu,Wv,Ww are positioned in a motor housing 2. A substantially annular stator frame 30 is connected to an end surface of the stator 3. The stator frame 30 has a connector receiving member 10 positioned on an outer periphery thereof (see FIG. 3 and FIG. 7).

The connector receiving member 10 is positioned within the motor housing 2, as shown in an embodiment of FIG. 6. A first connector member 20 connects with the connector receiving member 10, which taken together, form the electrical connector 4.

The stator frame 30 is substantially annular, as shown in the embodiments of FIGS. 1 and 7-9, and includes a substantially annular conductor plate 31 and an insulating stator frame housing 32. As shown in the embodiments of FIGS. 7-9, the term “substantially annular” denotes an annular shape in which inner peripheries of the stator frame 30 and the conductor plate 31 are circular with a center O, while outer peripheries of the stator frame 30 and the conductor plate 31 are substantially circular shapes.

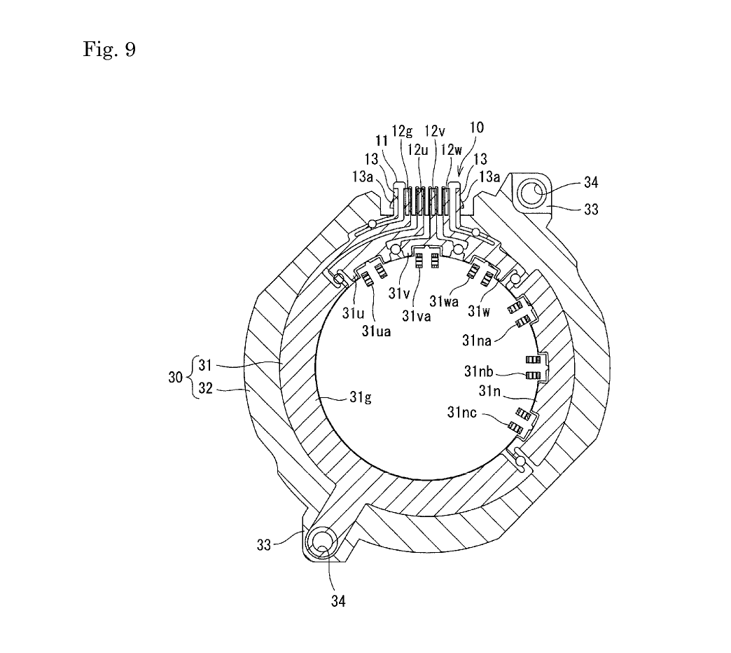

In an embodiment of FIG. 9, the conductor plate 31 has a grounding plate portion 31g, a U-phase portion 31u, a V-phase portion 31v, a W-phase portion 31w and a neutral grounding portion 31. The grounding plate portion 31g, the U-phase portion 31u, the V-phase portion 31v, the W-phase portion 31w and the neutral grounding portion 31n are positioned in this order. The grounding plate portion 31g, the U-phase portion 31u, the V-phase portion 31v, the W-phase portion 31w and the neutral grounding portion 31n are insulated with respect to each other. The conductor plate 31 is substantially annular and is formed by stamping a conductive metallic plate.

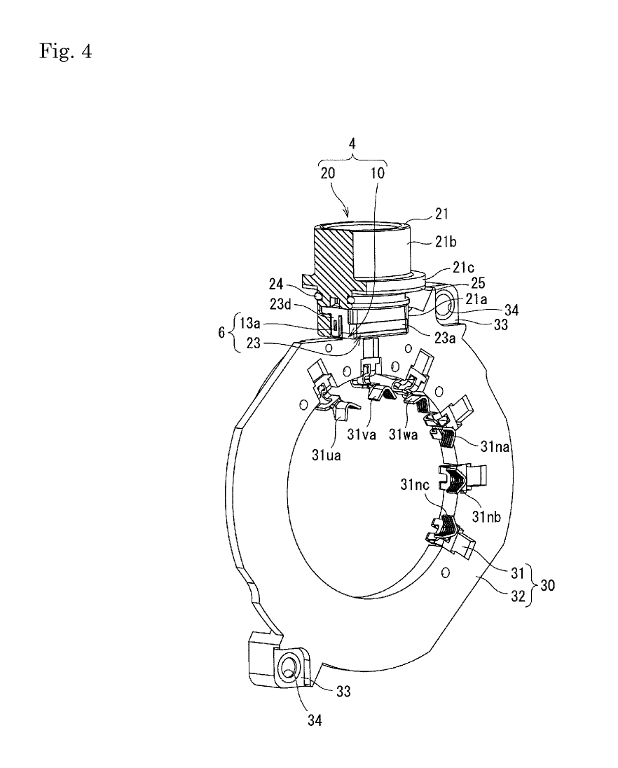

A first wire connecting member 31ua is connected to a first end of a U-phase winding Wu, and is positioned at an inner periphery of the U-phase portion 31u. A second wire connecting member 31va is connected to a first end of the V-phase winding Wv, and is positioned at an inner periphery of the V-phase portion 31v. A third wire connecting member 31wa is connected to a first end of the W-phase winding Ww, and is positioned at an inner periphery of the W-phase portion 31w. A fourth wire connecting member 31na is connected to an opposite second end of the U-phase winding Wu, and is positioned at an inner periphery of the neutral grounding portion 31n. A fifth wire connecting member 31nb is connected to an opposite second end of the V-phase winding Wv, and is positioned at an inner peripheral portion of the neutral grounding portion 31n. A sixth wire connecting member 31nc is connected to an opposite second end of the W-phase winding Ww, and is positioned at an inner periphery of the neutral grounding portion 31n. In an embodiment of FIG. 4, the wire connecting members 31ua, 31va, 31wa, 31na, 31nb and 31nc are crimp contacts that project from a surface of the conductor plate 31.

The wire connecting members 31ua, 31va, 31wa, 31na, 31nb and 31nc are disposed within a range of 180 degrees or less around the circumference on the inner peripheral edge of the conductor plate 31. In the embodiment of FIG. 7, an angle θ is formed by a first line L1 connecting an outer end of the first wire connecting member 31ua and the center O of the conductor plate 31, and a second line L2 connecting an outer end of the sixth wire connecting member 31nc and the center O of the conductor plate 31. The first and sixth wire connecting members 31ua,31nc being farthest apart from each other when seen from a plane of the conductor plate 31. The plurality of wire connecting members 31ua, 31va, 31wa, 31na, 31nb and 31nc are disposed along the inner periphery of the conductor plate 31, such that the angle θ is less than 180 degrees. In an embodiment, the plurality of wire connecting members 31ua, 31va, 31wa, 31na, 31nb and 31nc are disposed such that the angle θ is approximately 165 degrees.

The crimp contacts of the wire connecting members 31ua, 31va, 31wa, 31na, 31nb and 31nc open towards the center O of the conductor plate 31, as shown in an embodiment of FIG. 7.

In the embodiments of FIGS. 1-4 and 7-9, the stator frame housing 32 is formed to be substantially annular to cover the conductor plate 31, excepting the wire connecting members 31ua, 31va, 31wa, 31na, 31nb and 31nc. The conductor plate 31 is covered by the stator frame housing 32 through insert molding. Opposing portions on an outer periphery of the stator frame housing 32 are provided with a pair of mounting portions 33 for connecting the stator frame housing 32 to an end surface of the stator 3. Each mounting portion 33 is formed with a fastener receiving through hole 34, through which a mounting screw (not shown) is inserted.

In the embodiments of FIGS. 7-9, the connector receiving member 10 is disposed on the outer peripheral portion of the stator frame 30, and as shown in FIGS. 3-6, the first connector member 20 is mated with an outward facing side of the connector receiving member 10. The connector receiving member 10 comprises an insulating connector mount housing 11, a grounding contact 12g, a U-phase contact 12u, a V-phase contact 12v, and a W-phase contact 12w each contact 12g,12u,12v,12w being mounted at a predetermined pitch along a width direction of the connector mount housing 11. As shown in FIG. 9, the grounding contact 12g extends from an outer peripheral side of the conductor plate 31, from the grounding plate portion 31g. The U-phase contact 12u extends from the outer peripheral side of the conductor plate 31, from the U-phase portion 31u. The V-phase contact 12v extends from the outer peripheral side of the conductor plate 31, from the V-phase portion 31v. The W-phase contact 12w extends from the outer peripheral side of the conductor plate 31, from the W-phase portion 31w.

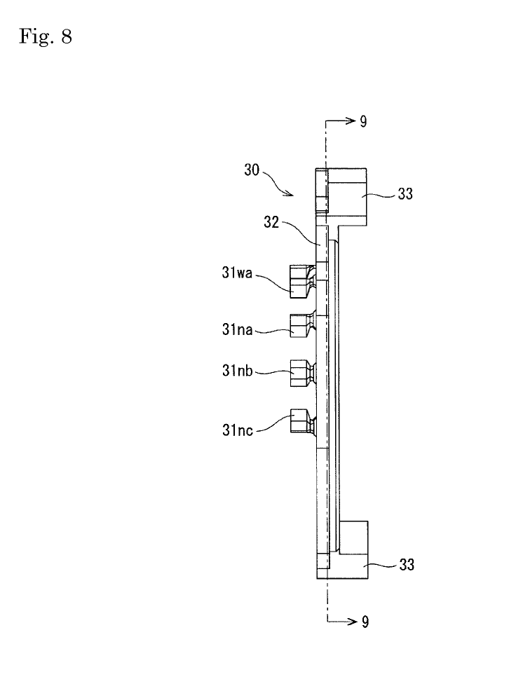

In the embodiments of FIGS. 7 and 8, the surface of the stator frame housing 32, from which the crimp contacts constituting the wire connecting members 31ua, 31va, 31wa, 31na, 31nb and 31nc project, and the surface of the connector receiving member 10, are both formed on the same flat surface.

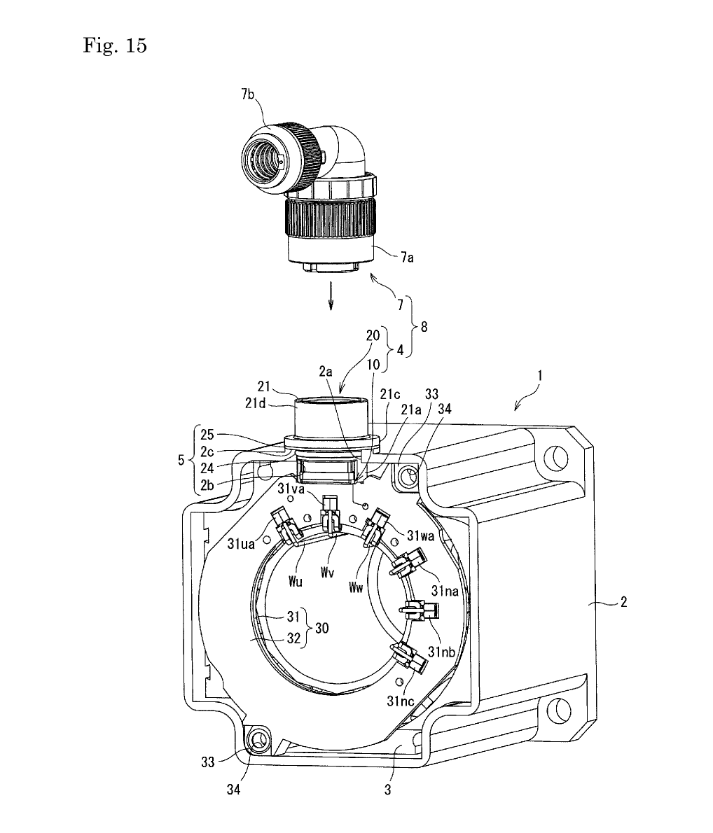

The first connector member 20 comprises an insulating connector housing 21 and a plurality of connector contacts 22 mounted to the connector housing 21, as shown in the embodiments of FIGS. 1-6. The connector housing 21 has a substantially cylindrical first mating portion 21a that mates with the connector receiving member 10, and a substantially cylindrical second mating portion 21b that mates with a complementary mating connector 7 to be described below (see FIG. 15). A flange 21c is positioned between the first mating portion 21a and the second mating portion 21b. Each connector contact 22 includes, as shown in the embodiments of FIGS. 6 and 7, a first contact portion 22a, each of which makes contact with each of the grounding contact 12g, the U-phase contact 12u, the V-phase contact 12v, and the W-phase contact 12w of the connector receiving member 10. The first contact portions 22a project into the first mating portion 21a. Each connector contact 22 further includes a second contact portion 22b positioned on an opposite end of the connector contact 22 to the first contact portion 22a, that engages each of the contacts (not shown) of the mating connector 7. The second contact portions 22b project into the second mating portion 21b.

In the embodiments of FIGS. 1-6, an aperture 2a is formed in the motor housing 2 to permit passage of the first mating portion 21a of the first connector member 20 upon mating the first connector member 20 to the connector receiving member 10.

A seal assembly 5 is positioned between the motor housing 2 and the first mating portion 21a of the first connector member 20 when the first connector 20 is mated with the connector receiving member 10, as shown in the embodiments of FIGS. 1 and 6. The seal assembly 5 comprises a first seal surface 2b formed on the aperture 2a, and an O ring 24 positioned on an outer periphery of the first mating portion 21a of the first connector member 20. The O ring 24 contacts the first seal surface 2b and seals a first space between the motor housing 2 and the first mating portion 21a.

The seal assembly 5 further comprises a second seal surface 2c formed on an upper surface of the motor housing 2, and an annular sealing member 25 positioned on a lower surface of the flange 21c. The sealing member 25 abuts the second seal surface 2c formed on the upper surface of the motor housing 2 when the first connector member 20 is mated with the connector receiving member 10, as shown in the embodiment of FIG. 6. With this positioning, a second space between the lower surface of the flange 21c of the first connector member 20 and the second seal surface 2c is sealed.

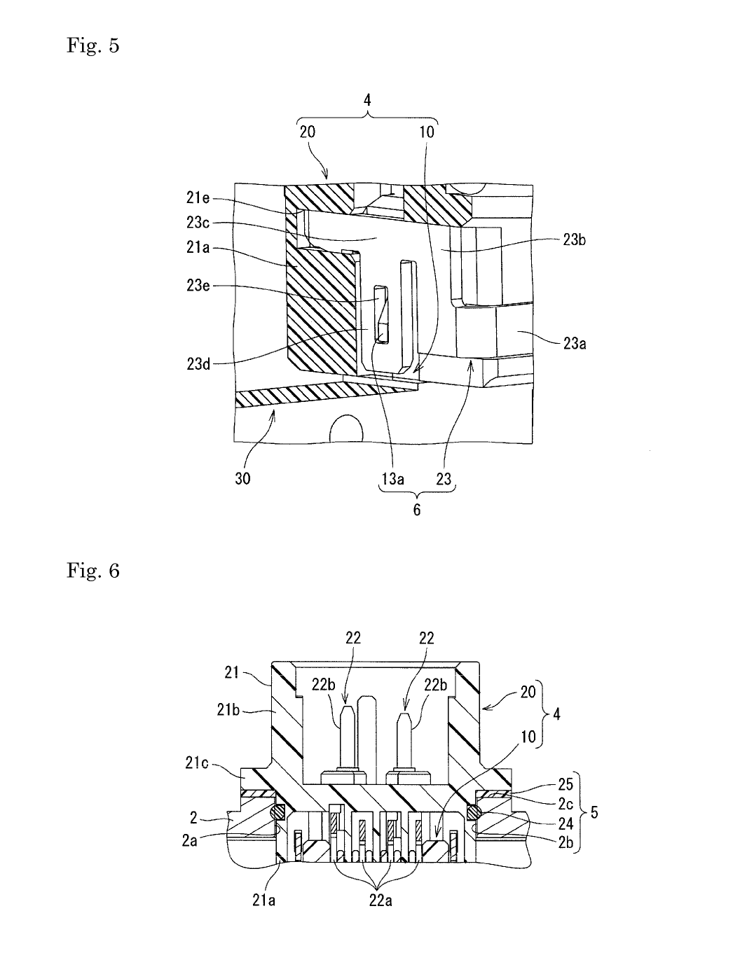

In the embodiments of FIGS. 4 and 5, the connector receiving member 10 and the first connector member 20 have a locking mechanism 6 that engages when the first connector member 20 is connected to the connector receiving member 10.

The locking mechanism 6 includes protrusions 13a positioned on the connector receiving member 10 and locking members 23 positioned on the first connector member 20. The locking members 23 includes cantilevered locking arms 23d that engage the protrusions 13a to lock the first connector 20 to the connector receiving member 10. As shown in the embodiment of FIG. 9, the protrusions 13a are formed as metallic members 13, which in turn, are insert molded and fixed to the connector mount housing 11. The metallic members 13, including the protrusions 13a, are positioned on opposite sides of the connector mount housing 11 as a pair.

In the embodiment of FIG. 4, the locking member 23 comprises a base plate 23a extending along a front surface of the first mating portion 21a, perpendicular to the first mating portion 21a. In the embodiment of FIG. 5, coupling plate portions 23b are bent substantially perpendicular with respect to the base plate 23a, and are formed on the opposite ends in the lateral direction of the base plate 23a, where only one end in the lateral direction of the base plate 23a is shown in FIG. 5. Anchoring members 23c extend from upper ends of the coupling plate portions 23b and the elastic locking arms 23d extend downward from lower ends of substantially central portions of the anchoring members 23c. Each cantilevered locking arm 23d has a protrusion receiving space 23e into which each protrusion 13a is positioned. The locking member 23 is formed by stamping and forming a metallic plate.

In the embodiment of FIG. 5, the locking member 23 is attached to the first mating portion 21a by press-fitting the anchoring members 23c into anchoring member receiving spaces 21e formed in the first mating portion 21a.

Next, the assembly steps for mounting the stator frame 30 to the stator, connecting the wire connecting members to the end portions of the stator windings, and mating the electrical connector 4 to the connector receiving member 10 will be described with reference to the embodiments of FIGS. 1 and 10-14.

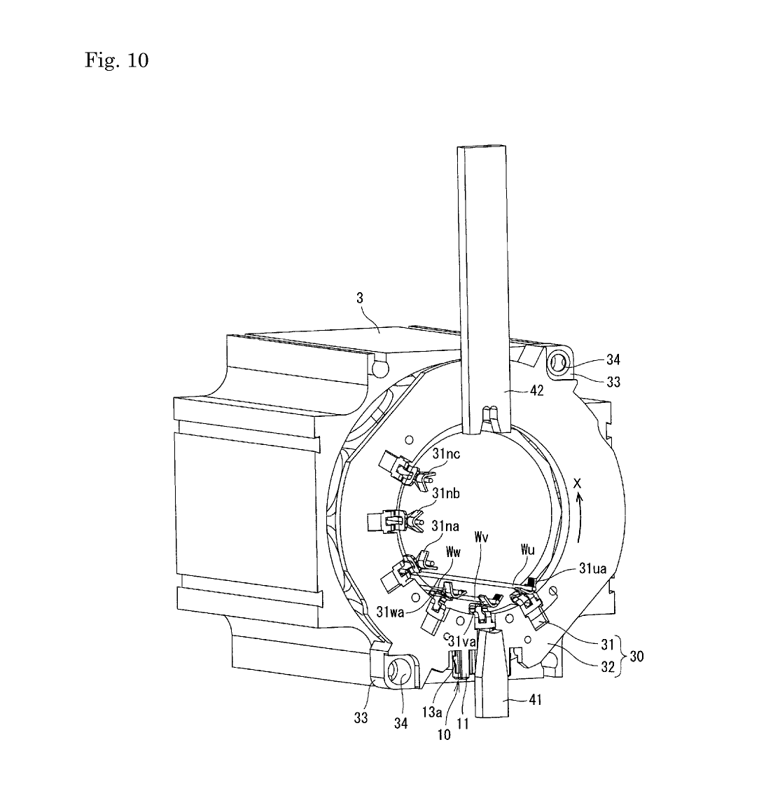

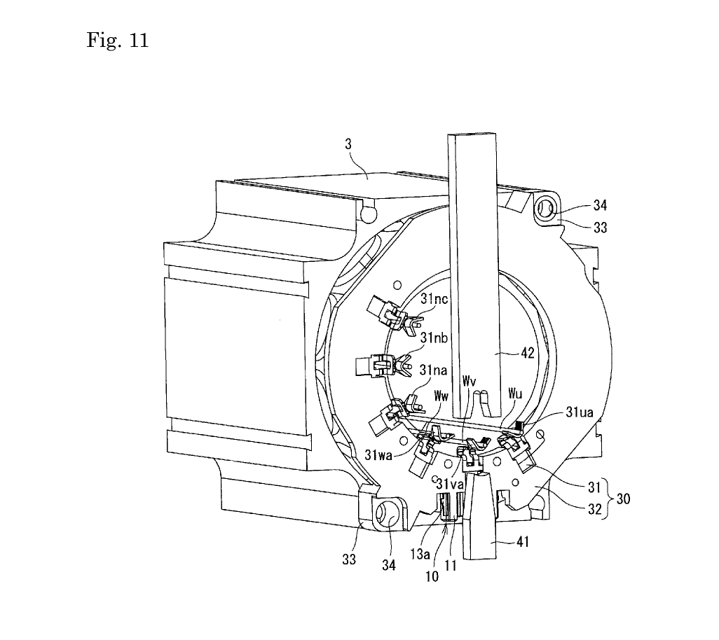

The stator frame 30 is first mounted to the end surface of the stator 3, as shown in the embodiment of FIG. 10. Mounting of the stator frame 30 to the stator 3 is performed by inserting a fastener through the fastener receiving through holes 34 of the respective mounting portions 33 of the stator frame 30. In an embodiment, the fastener is mounting with screws (not shown), although one of ordinary skill in the art would appreciate that other fasteners may also be used.

In the embodiments of FIGS. 10 and 11, the first wire connecting member 31ua is crimped to the first end of the U-phase winding Wu using an anvil 41 and a crimper 42. The stator 3, mounted to the stator frame 30, is then rotated in a direction of arrow X shown in FIG. 10, and the second wire connecting member 31va, positioned next to the first wire connecting member 31ua, is crimped to the first end of the V-phase winding Wv. The stator 3 is further rotated in the direction of arrow X and the third wire connecting member 31wa, positioned next to the second wire connecting member 31va, is then crimped to the first end of the W-phase winding Ww. The stator 3 is then further rotated in the direction of arrow X and the fourth wire connecting member 31na, positioned next to the third wire connecting member 31wa, is crimped to the second end of the U-phase winding Wu. Similarly, the stator 3 is further rotated in the direction of arrow X and the fifth wire connecting member 31nb, positioned next to the fourth wire connecting member 31na, is then crimped to the second end of the V-phase winding Wv. Again, the stator 3 is further rotated in the direction of arrow X and the sixth wire connecting member 31nc, positioned next to the fifth wire connecting member 31nb, is then crimped to the second end of the W-phase winding Ww.

Finally, the stator 3 is positioned within the motor housing 2.

Since the wire connecting members 31ua, 31va, 31wa, 31na, 31nb, 31nc are crimp contacts, the connection of these wire connecting members to the first and second ends of the U-phase winding Wu, the V-phase winding Wv and the W-phase winding Ww can be performed through crimping operations. Therefore, automation of the connection of the wire connecting members 31ua, 31va, 31wa, 31na, 31nb and 31nc to the first and second ends of the U-phase winding Wu, the V-phase winding Wv and the W-phase winding Ww greatly simplified over conventional designs.

Since the wire connecting members 31ua, 31va, 31wa, 31na, 31nb,31nc are disposed along the inner peripheral surface of the conductor plate 31, the length of the first and second ends of the U-phase winding Wu, the V-phase winding Wv and the W-phase winding Ww necessary to connect with the wire connecting members 31ua, 31va, 31wa, 31na, 31nb,31nc is greatly reduced. This is because the first and second ends of the U-phase winding Wu, the V-phase winding Wv and the W-phase winding Ww extend from the inner peripheral side of the conductor plate 31 to the wire connecting members 31ua, 31va, 31wa, 31na, 31nb,31 nc. Therefore, output losses of the motor due to excessive lengths of the first and second ends from the windings to the wire connecting members are reduced.

Further, since the wire connecting members 31ua, 31va, 31wa, 31na, 31nb, 31nc are disposed within a range of 180 degrees along the inner periphery of the conductor plate 31, the crimper 42 movement interference by into wire connecting members is avoided. Therefore automation of crimping operations is possible. If the wire connecting members 31ua, 31va, 31wa, 31na, 31nb and 31nc were disposed outside the range of 180 degrees of the inner periphery of the conductor plate 31, such as in conventional designs, the crimper 42 will contact wire connecting members other than the wire connecting member the crimper 42 is performing the crimping operation on.

Crimp contacts constituting the wire connecting members 31ua, 31va, 31wa, 31na, 31nb, 31nc open towards the center O of the conductor plate 31, as shown in the embodiment of FIG. 7. Therefore, the wire connecting members 31ua, 31va, 31wa, 31na, 31nb, 31nc are sequentially crimped to the stator windings Wu,Wv,Ww, by rotating the stator 3 mounted with the stator frame 30 in a direction of arrow X and performing individual crimping operations using the anvil 41 and the crimper 42. This operation is compared to that of the conventional design, where the direction in which each crimp contact opens, differs between crimp contacts, requiring the positions of the anvil 41 and the crimper 42 to be changed each time a crimping operation is completed, precluding automated crimping.

At this point in the assembly, the first connector 20 is separated from the connector receiving member 10. Since the surface of the stator frame housing 32 of the stator supporting frame 30, from which the wire connecting portions 31ua, 31va, 31wa, 31na, 31nb and 31nc project, and the surface of the connector receiving member 10 are formed on the same flat surface, the stator supporting frame 30 and the connector receiving member 10 will not interfere when performing crimping using the anvil 41 and the crimper 42, as shown in the embodiments of FIGS. 10 and 11.

Such a structure differs from the conventional connector assemblies, where the first connector 20 is integral with the connector receiving member 10 at the start of the assembly process. In the conventional connector assemblies, the first connector 20 will be in the way and it will be impossible to position the crimp contacts proximate of the anvil 41.

Further, in the conventional connector assemblies, the surface of the stator frame housing 32 from which the crimp contacts project, and the surface of the connector receiving member 10 are not formed on the same flat surface. Consequently, the connector receiving member 10 is in the way, making it impossible to position the crimp contacts proximate of the anvil 41. Otherwise, the stator frame housing 32 will be in the way and operations of the crimper 42 would be hindered.

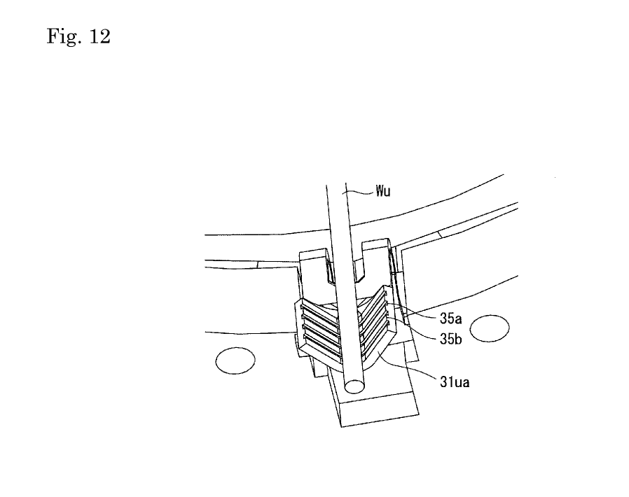

The wire connecting portions 31ua, 31va, 31wa, 31na, 31nb and 31nc each have a plurality of grooves 35a and crimping protrusions 35b that alternately extend orthogonally to the U-phase winding Wu, the V-phase winding Wv and the W-phase winding Ww, as shown in an embodiment of FIG. 12. While the embodiment of FIG. 12 only shows the wire connecting portion 31ua, the remaining wire connection portions 31va, 31wa, 31na, 31nb and 31nc are understood to be substantially the same as the wire connection portion 31ua. The U-phase winding Wu, the V-phase winding Wv, and the W-phase winding Ww are formed of conductive wires. When the wire connecting members 31ua, 31va, 31wa, 31na, 31nb and 31nc are crimped to the end portions of the U-phase winding Wu, the V-phase winding Wv and the W-phase winding Ww, the crimping protrusions 35b will break through insulated coatings of the conductive wires to contact a conductor core of the wires. Accordingly, by performing crimping operations upon the wire connecting portions 31ua, 31va, 31wa, 31na, 31nb and 31nc of crimp contacts, a separate operation of removing the insulated coatings of conductive wires or performing solder connecting operations are unnecessary, thus permitted automated wire connecting operations.

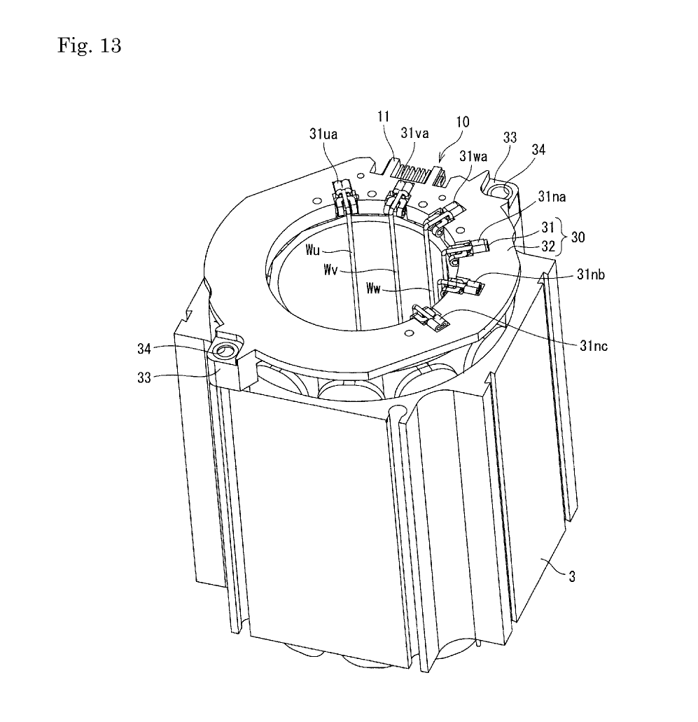

Upon completion of crimping operations of the U-phase winding Wu, the V-phase winding Wv, and the W-phase winding Ww, the crimp contacts 31ua, 31va, 31wa, 31na, 31nb and 31nc are folded back to overlap on the conductor plate 31 as shown in the embodiment of FIG. 13.

Next, though not shown in the drawings, resin is filled into a space between the motor housing 2 and the connector receiving member 10 to reliably achieve insulation among the grounding contact 12g, the U-phase contact 12u, the V-phase contact 12v and the W-phase contact 12w.

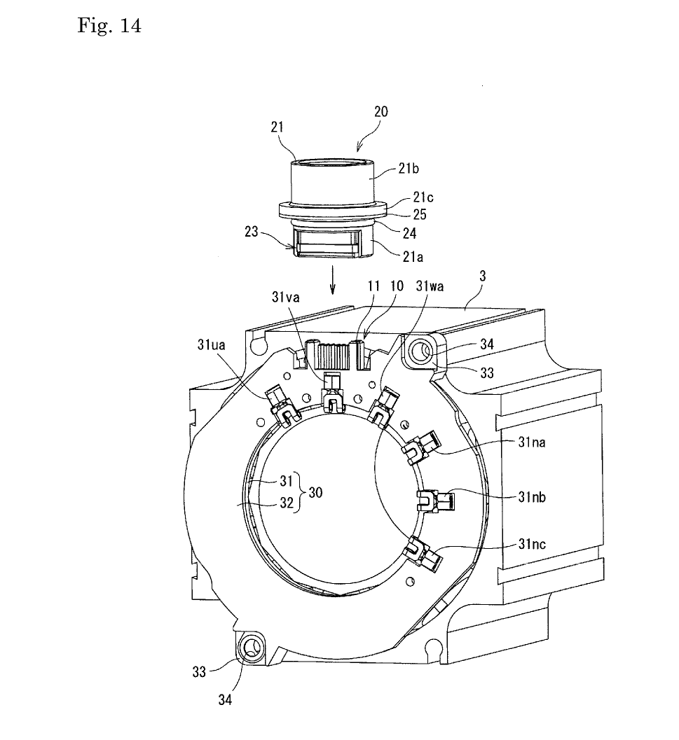

In the embodiment of FIG. 14, the first mating portion 21a of the first connector member 20 is mated together with the connector receiving member 10. The electrical connector 4 is then mounted to the motor 1, as shown in the embodiment of FIG. 1.

Then the first mating portion 21a of the first connector member 20 is mated with the connector receiving member 10, the connector contacts 22 of the first connector member 20 contact the grounding contact 12g, the U-phase contact 12u, the V-phase contact 12v and the W-phase contact 12w of the connector receiving member 10. With this arrangement, the first connector member 20 will be electrically connected to the connector receiving member 10.

When the first mating portion 21 a of the first connector member 20 is mated with the connector receiving member 10, the elastic locking arms 23d will be elastically displaced outward by the protrusions 13a, as shown in the embodiments of FIGS. 4 and 5. Upon completion of mating, the protrusions 13a are positioned in the protrusion receiving spaces 23e and the elastic locking arms 23d elastically return to their original position. With this arrangement, the first connector member 20 and the connector receiving member 10 are locked together. Detachment of the first connector 20 from the connector receiving member 10 is therefore preventable without requiring the use of additional elements, such as fasteners, etc. In this respect, since the elastic lock arms 23d engage the protrusions 13a, the first connector 20 is held securely to the connector receiving member 10.

During mating of the first mating portion 21 a of the first connector 20 with the connector receiving member 10, the first mating portion 21 a is received through the aperture 2a formed on the housing 2 to mate with the connector receiving member 10. The O ring 24 on the first connector 20 contacts the first sealing surface 2b of the housing 2 to seal the space between the housing 2 and the first mating portion 21a. With this arrangement, a reliable seal is created in the space between the motor housing 2 and the first mating portion 21a of the first connector 20.

When the first mating portion 21a is mated with the connector receiving member 10, the sealing member 25 positioned on the lower surface of the flange 21c abuts the second seal surface 2c formed on the upper surface of the motor housing 2, as shown in the embodiments of FIG. 6. Therefore, a seal is formed in the space between the lower surface of the flange 21c and the second seal surface 2c. Accordingly, the space between the motor housing 2 and the flange 21c is reliably sealed.

The mating connector 7 is then mated with the first connector member 20, as shown in the embodiment of FIG. 15. The mating connector 7 comprises a connector mating portion 7a that mates with the second mating portion 21b of the first connector member 20, and a cable connecting portion 7b, to which a power supply cable (not shown) is connected.

Since the mating connector 7 connected to the power supply through the power supply cable and to the first connector member 20, power is supplied to the motor 1 side.

A motor connector assembly 8, which includes the electrical connector 4 and the mating connector 7, is mated with the first connector member 20 of the electrical connector 4.

While embodiments of the present invention have been described above, the present invention is not limited to these, and one of ordinary skill in the art would recognize that various changes and improvements may be made without departure from the spirit and scope of the invention.

For example, the surface of the stator frame housing 32 on the side the crimp contacts constituting the wire connecting members 31ua, 31va, 31wa, 31na, 31nb and 31nc project and the surface of the connector receiving member 10 are described above as being formed on the same flat surface. However, in another embodiment, the surface of the connector receiving member 10 does not project farther than the surface of the stator frame housing 32 but instead is recessed.

Further, the stator frame 30 might be mounted to the motor housing 2 instead of the stator 3.

Still further, the wire connecting members 31ua, 31va, 31wa, 31na, 31nb, 31nc might be positioned on the outer peripheral portion instead of the inner peripheral portion of the stator frame 30. That is, the wire connecting members 31ua, 31va, 31wa, 31na, 31nb, 31nc are disposed along a circumference of the conductor plate 31.

What is claimed is:

1. A stator frame, comprising:
a substantially annular conductor plate having an inner peripheral edge defining an O-shaped opening;
a connector receiving member positioned on an outer peripheral side of the stator frame;
a plurality of wire connecting members positioned on a conductor plate surface of the conductor plate along the inner peripheral edge, each wire connecting member being connected to first or second end portions of stator windings, and having an electrical connection with the connector receiving member; and
a substantially annular insulating stator frame housing mounted to a stator, and covering the conductor plate except for the conductor plate surface the wire connecting members are positioned thereon.

2. The stator frame of claim 1, wherein the plurality of wire connecting members are crimp contacts.

3. The stator frame of claim 1, wherein the plurality of wire connecting members are disposed within a range of 180 degrees or less around the circumference of the inner peripheral edge of the conductor plate.

4. The stator frame of claim 1, wherein the plurality of wire connecting members are disposed at approximately 165 degrees around the circumference of the inner peripheral edge of the conductor plate.

5. The stator frame of claim 1, wherein the stator frame is mounted to a stator or a motor housing.

6. The stator frame for motor as claimed in claim 2, wherein the crimp contacts include coating through portions that pass through coatings of the end portions of the stator windings.

7. The stator frame for motor as claimed in claim 2, wherein the crimp contacts are open towards a center of the conductor plate.

8. The stator frame of claim 2, wherein the crimp contacts project from a conductor plate surface of the conductor plate.

9. The stator frame of claim 8, wherein a surface of the connector receiving member extends in the same plane as the conductor plate surface.

10. The stator frame of claim 1, wherein the stator frame further comprises fastener receiving through holes.

11. The stator frame of claim 10, wherein the stator frame is connected to the stator through fasteners positioned through the fastener receiving through holes.
